(19) United States
(12) Patent Application Publication
(10) Pub. No.: US 2007/0247434 A1
(43) Pub. Date: Oct. 25, 2007

(54) METHOD, APPARATUS, AND COMPUTER PROGRAM PRODUCT FOR ENTRY OF DATA OR COMMANDS BASED ON TAP DETECTION

(76) Inventors: Ryan Kirk Cradick, Rochester, MN (US); Zachary Adam Garbow, Rochester, MN (US); Kevin Glynn Paterson, San Antonio, TX (US)

Correspondence Address: IBM CORPORATION;ROCHESTER IP LAW DEPT. 917, 3605 HIGHWAY 52 NORTH, ROCHESTER, MN, 55901-7829, US

(21) Appl. No.: 11/379,260

(22) Filed: Apr. 19, 2006

(51) Int. Cl. G06F 3/041

(52) U.S. Cl. 345/173

(57) ABSTRACT

An electronic device includes a housing that encloses a processor and a memory coupled to the processor. One or more tap sensors provide a tap signal in response to a user's tap on an outside surface of the housing. A position detecting mechanism determines the position of a user's tap on the outside surface of the housing based on the tap signal. In one embodiment, the position of the user's tap is determined through triangulation using the tap signal from each of plural accelerometers mounted at different locations. A matching mechanism compares the determined position of the user's tap and one or more virtual buttons configured on the outside surface of the housing. In accordance with the preferred embodiments, the size and location of one or more virtual buttons are dynamically configured by the user and/or by a software program loaded on the electronic device.

### BACKGROUND OF THE INVENTION

1. Field of Invention

The present invention relates in general to the field of user interfaces for inputting data or commands into an electronic device. More particularly, the present invention relates to a method, apparatus, and computer program product for entry of data or commands into an electronic device based on tap detection with respect to one or more virtual buttons configured on the housing of the electronic device.

2. Background Art

Electronic devices, such as computer systems, computer peripherals, personal data assistants, cellular phones, personal audio/video devices (e.g., MP3 players), digital cameras, audio/video equipment (e.g., televisions, stereos, DVD players and recorders, etc.), security devices, and the like, require user interfaces for inputting data and/or commands. The most common user interface is the button or key (hereinafter generically referred as “buttons” or “input buttons”). Although buttons allow data and commands to be quickly and unambiguous entered into electronic devices, the number, location and size of the buttons are typically fixed. The versatility of such non-configurable buttons is limited because they are not customizable to individual users or particular applications. For example, an elderly person may require larger buttons that are more easily found and pushed.

Additionally, software programs that are loaded and run on an electronic device must conform to the inputs provided by the device's non-configurable buttons. This is an increasingly troublesome problem because many electronic devices are able to load and run different programs. Consequently, these programs must utilize the inputs provided by the device's non-configurable buttons, which may be difficult to use with respect to particular applications. For example, a particular software program may require more inputs than provided by the device's non-configurable buttons.

One current solution to this problem is the touch screen display. Although this user interface is able to dynamically configure the input buttons, the location and size of the touch screen display limits the location and size of the individual input buttons. For example, the touch screen display of a personal data assistant typically occupies a small portion of the device's overall surface area, and thus the space available for the input buttons is small compared to the device's overall surface area. Additionally, increasing the space available on the touch screen display for the input buttons reduces the space available for the display output, because both the input buttons and the display output must share the same limited surface area of the touch screen display.

A need exists for an enhanced user interface for entry of data or commands into an electronic device using dynamically configurable buttons.

### SUMMARY OF THE INVENTION

According to the preferred embodiments of the present invention, an electronic device includes a housing that encloses a processor and a memory coupled to the processor. One or more tap sensors provide a tap signal in response to a user's tap on an outside surface of the housing. A position detecting mechanism determines the position of a user's tap on the outside surface of the housing based on the tap signal. According to the preferred embodiments of the present invention, the position of the user's tap is determined through triangulation using the tap signal from each of plural accelerometers mounted at different locations. A matching mechanism compares the determined position of the user's tap and one or more virtual buttons configured on the outside surface of the housing. According to the preferred embodiments of the present invention, the size and location of one or more virtual buttons are dynamically configured by the user and/or by a software program loaded on the electronic device.

### BRIEF DESCRIPTION OF THE DRAWINGS

The preferred exemplary embodiments of the present invention will hereinafter be described in conjunction with the appended drawings, where like designations denote like elements.

FIG. 1 is a top plan view of an electronic device that constitutes a PDA having virtual buttons and tap sensors in accordance with the preferred embodiments of the present invention.

FIG. 2 is a block diagram of an exemplary hardware and software environment for the electronic device shown in FIG. 1.

FIG. 3 is a front elevational view of an electronic device that constitutes a television having virtual buttons and tap sensors in accordance with the preferred embodiment of the present invention.

FIG. 4 is a flow diagram illustrating the activities of a position detecting mechanism in accordance with the preferred embodiments of the present invention.

FIG. 5 is a flow diagram illustrating the activities of a matching mechanism in accordance with the preferred embodiments of the present invention.

FIG. 6 is a flow diagram illustrating the activities of a virtual button configuration mechanism in accordance with the preferred embodiments of the present invention.

### DETAILED DESCRIPTION OF THE PREFERRED EMBODIMENTS

1. Overview

In accordance with the preferred embodiments of the present invention, an electronic device includes a housing that encloses a processor and a memory coupled to the processor. One or more tap sensors provide a tap signal in response to a user's tap on an outside surface of the housing. A position detecting mechanism determines the position of a user's tap on the outside surface of the housing based on the tap signal. In accordance with the preferred embodiments of the present invention, the position of the user's tap is determined through triangulation using the tap signal from each of plural accelerometers mounted at different locations. A matching mechanism compares the determined position of the user's tap and one or more virtual buttons configured on the outside surface of the housing. In accordance with the preferred embodiments of the present invention, the size and location of one or more virtual buttons are dynamically configured by the user and/or by a software program loaded on the electronic device.

2. Detailed Description

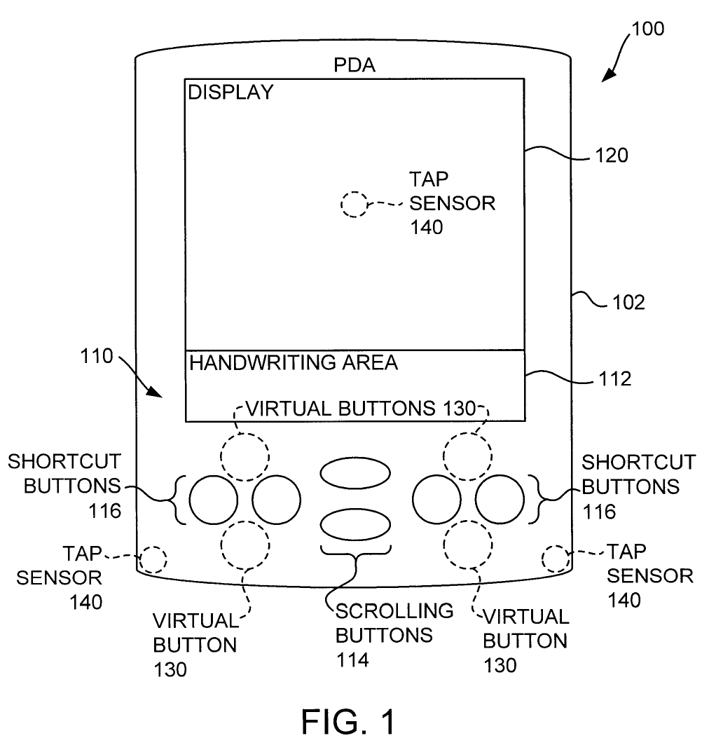

Referring now to FIG. 1, there is depicted, in a top plan view, an electronic device 100 consistent with the present invention. As shown in FIG. 1, electronic device 100 is a personal data assistant (PDA). For the purposes of the present invention, however, electronic device 100 may represent any type of electronic device that requires a user interface for inputting data and/or commands, such as computer systems, computer peripherals, personal data assistants, cellular phones, personal audio/video devices (e.g., MP3 players), digital cameras, audio/video equipment (e.g., televisions, stereos, DVD players and recorders, etc.), security devices, and the like.

Electronic device 100 includes a number of inputs and outputs for communicating information externally. For interface with a user, electronic device 100 typically includes one or more conventional user inputs 110 (e.g., a keypad, a stylus, a keyboard, a mouse, a trackball, a joystick, a touchpad, and/or a microphone, among others) and one or more displays 120 (e.g., an LCD display panel, a speaker, and/or a CRT monitor, among others). Conventional user inputs 110 and display 120 are typically incorporated into a housing 102 that encloses the internal components of electronic device 100, such as its processor and memory.

In the exemplary PDA shown in FIG. 1, conventional user inputs 110 include a handwriting area 112, scrolling buttons 114, and shortcut buttons 116. However, the conventional user inputs 110 shown in FIG. 1 are exemplary. Those skilled in the art will appreciate that other conventional user inputs may be used in addition to, or in lieu of, the conventional user inputs 110 shown in FIG. 1. For example, conventional user inputs 110 may additionally, or alternatively, include a voice recognition system and a microphone to allow activation of various functions by voice command. Similarly, display 120 may additionally, or alternatively, include a voice synthesis system and a speaker to allow playback of voice messages. Conventional user inputs 110 and/or display 120 may also be omitted entirely or combined in the form of a touch sensitive screen.

In addition to the conventional inputs and outputs discussed above, electronic device 100 includes one or more virtual buttons (shown in FIG. 1 using a dashed line and denoted with reference numeral 130) dynamically configured on housing 102 in accordance with the preferred embodiments of the present invention. Alternatively, virtual buttons 130 may be used in lieu of the conventional user inputs 110 shown in FIG. 1. As discussed in more detail below, according to the preferred embodiments of the present invention, virtual buttons 130 are dynamically configured anywhere on housing 102 of electronic device 100. Preferably, the size and location of virtual buttons 130 are dynamically configured by the user and/or by a software program loaded on electronic device 100.

The ability to dynamically configure the virtual buttons anywhere on the housing of the electronic device and with any size in accordance with the preferred embodiments of the present invention is a highly desirable feature. For example, the virtual buttons may be configured to accommodate an elderly user's physical capabilities (which may be limited by conditions such as arthritis, poor vision, etc.) by defining the virtual buttons in convenient locations and with larger sizes. Moreover, software programs are not limited by the amount or location of pre-existing buttons, and each software program can define its own virtual buttons to assist in the software program's unique functionality.

Actuation of an individual virtual button 130 is accomplished by a user's tap on the outside surface of housing 102 within a boundary defined by that virtual button's configuration. The boundary is defined by the virtual button's location and size, which were previously configured by a user and/or a software program loaded on electronic device 100.

The user's tap on the outside surface of housing 102 is sensed by one or more tap sensors (shown in FIG. 1 using a dashed line and denoted with reference numeral 140). When a user taps on the outside surface of housing 102 (e.g., by using one or more of his/her fingers, a stylus, etc.), one or more components (e.g. the housing 102) of electronic device 100 react to the user's tap in manner that is sensed by tap sensors 140. For example, tap sensors 140 may sense the reaction of housing 102 in the form of vibration, acoustic energy, a change in magnetic field, etc. The reaction that is sensed by an individual tap sensor 140 preferably varies depending on how far that tap sensor 140 is from the user's tap.

As shown in FIG. 1, preferably three or more tap sensors 140 are used to provide tap signals for triangulation of the position of the user's tap on the outside surface of housing 102. However, those skilled in the art will appreciate that any number of tap sensors may be used. For example, a single tap sensor may be used in the case where the virtual buttons are to be arranged along a line. Tap sensors 140 are mounted in suitable locations so that each provides a tap signal in response to a user's tap on the outside surface of housing 102. For example, tap sensors 140 may be each attached onto, or integrated into, housing 102 in a plane generally parallel to the top surface thereof, i.e., the surface of housing 102 that includes display 120. Alternatively, it may be desirable to place at least one of the tap sensors 140 displaced from the top surface of housing 102 so as to better sense the user's tap over the entire outside surface of housing 102. For example, the uppermost tap sensor 140 shown in FIG. 1 may be mounted on a circuit board that underlies display 120.

In general, it is preferable to arrange tap sensors 140 in the form an equilateral triangle for purposes of triangulation. In an alternative embodiment of the present invention, a single 3-in-1 tap sensor may be used to provide three tap signals for triangulation, in lieu of three separate tap sensors.

As mentioned above, the reaction to a user's tap is sensed by tap sensors 140. This reaction may be in the form of vibration, acoustic energy, a change in magnetic field, etc. Consequently, the types of sensors that are suitable for use as tap sensors 140 vary depending on the type of reaction that is to be sensed. For example, accelerometers are suitable for sensing a vibration-type response to a user's tap, magnetic sensors are suitable for sensing a magnetic field change-type response to a user's tap, and acoustic sensors are suitable for sensing an acoustic energy-type response to a user's tap. Examples of sensors that are suitable for use as tap sensors 140 include the following: thermal accelerometers (dual- or tri-axis), such as the MESMIC MXC6202 Dual Accelerometer (available from MEMSIC, Inc. USA, North Andover, Mass.); micro-electro-mechanical-systems (MEMS) accelerometers (dual- or tri-axis), such as the Analog Devices ADXL50 Accelerometer (available from Analog Devices, Inc., Norwood, Mass.), the Hitachi H48C Accelerometer Module (available from Hitachi Metals America, Ltd., Purchase, N.Y.), and the Kionix KXP84 Series (available from Kionix, Inc., Ithaca, N.Y.); magnetic sensors, such as the Hitachi HM55B 2-AXIS MAGNETIC COMPASS SENSOR (available from Hitachi Metals America, Ltd., Purchase, N.Y.); and acoustic sensors, such as microphones.

Housing 102 is preferably provided in the form of a thin, rigid outer shell made of a plastic material, such as injection molded ABS thermoplastic, that reacts to a user's tap in a desired manner. However, those skilled in the art will appreciate that other materials, such as metal, that react to a user's tap in a desired manner may be used to provide housing 102 in lieu of plastic. In the case where tap sensors 140 comprise magnetic sensors, a magnetic material may be incorporated in or provided on housing 102. The magnetic material generates a magnetic field, and the magnetic sensors detect a change in the magnetic field when a user taps housing 102. The change in the magnetic field that is detected by the magnetic sensors is produced when part of housing 102 is slightly depressed by the user's tap.

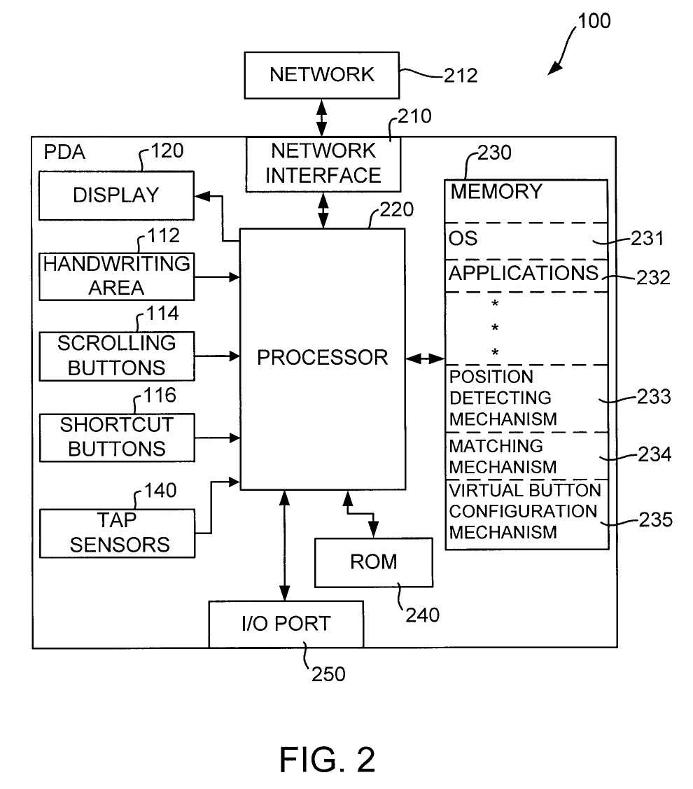

FIG. 2 is a block diagram of an exemplary hardware and software environment for electronic device 100 shown in FIG. 1. As shown in FIG. 2, a network interface 210 may be used to connect electronic device 100 to one or more computers (e.g., a desktop or PC-based computer, workstations, a PC-based server, a minicomputer, a midrange computer, a mainframe computer, etc.) through a network 212. In the alternative, electronic device 100 may be a stand-alone device. For example, network 212 may be a local-area network (LAN), a wide-area network (WAN), a wireless network, and a public network (e.g., the Internet). Moreover, any number of computers and other devices may be networked through the network 212, e.g., multiple servers.

Electronic device 100 typically includes at least one processor 220 coupled to a memory 230. Processor 220 may represent one or more processors (e.g., microprocessors), and memory 230 may represent the random access memory (RAM) devices comprising the main storage of electronic device 100, as well as any supplemental levels of memory, e.g., cache memories, non-volatile or backup memories (e.g., programmable or flash memories), read-only memories, etc. In addition, memory 230 may be considered to include memory storage physically located elsewhere in electronic device 100, e.g., any cache memory in a processor 220, as well as any storage capacity used as a virtual memory, e.g., as stored on a mass storage device, if any, or on another computer coupled to electronic device 100 via network 212.

Electronic device 100 typically includes a read-only memory (ROM) 240 coupled to processor 220. ROM 240 may represent one or more non-volatile programmable ROMs, such as electronically erasable programmable read-only memories (EEPROMs), flash ROMs, erasable programmable read-only memories (EPROMs), etc.

For additional storage, electronic device 100 may optionally include one or more mass storage devices (not shown), e.g., a floppy or other removable disk drive, a hard disk drive, a direct access storage device (DASD), an optical drive (e.g., a CD drive, a DVD drive, etc.), and/or a tape drive, among others.

Electronic device 100 typically includes an I/O port 250 for communication with a host computer (not shown in FIG. 2). Electronic device 100 communicates with the host computer through a wired and/or wireless link. For example, I/O port 250 may represent a serial port (e.g., a RS-232 interface, a RS-422 interface, a RS-423 interface, a universal serial bus (USB) port, a USB HotSync® port, etc.), a parallel port, a modem port, or a wireless port (e.g., an infrared port, radio frequency (RF) port, etc.).

It should be appreciated that electronic device 100 typically includes suitable analog and/or digital interfaces between processor 220 and each of network 212, memory 230, ROM 240 and I/O port 250, as is well known in the art. Similarly, as is also well known in the art, electronic device 100 includes suitable analog and/or digital interfaces between processor 220 and each of the conventional inputs and outputs (i.e., handwriting area 112, scrolling buttons 114, shortcut buttons 116 and display 120), as well as tap sensors 140.

Electronic device 100 operates under the control of an operating system 231, and executes various computer software applications, components, programs, objects, modules, etc. (e.g., executable programs 232-235, among others). Moreover, various applications, components, programs, objects, modules, etc. may also execute on one or more processors in another computer coupled to electronic device 100 via network 212, e.g., in a distributed or client-server computing environment, whereby the processing required to implement the functions of a computer program may be allocated to multiple computers over a network. As discussed in more detail below, electronic device 100 also includes a position detecting mechanism 233, a matching mechanism 234, and a virtual button configuration mechanism 235 according to the preferred embodiments of the present invention.

Typically, the operating system 231 and various computer software applications, components, programs, objects, modules, etc. (e.g., application programs 232-235) are loaded into memory 230 from non-volatile memory, e.g., ROM 240 and/or a mass storage device, if any. For example, relatively modest electronic devices, such as PDAs, cellular phones and related wireless devices, embedded controllers, etc., typically do not contain a mass storage device and thus the operating system 231 and the various computer software applications, components, programs, objects, modules, etc. are typically loaded into memory 230 from ROM 240 upon power up. On the other hand, relatively robust electronic devices, such as notebook computers, typically contain a mass storage device and thus the operating system 231 and the various computer software applications, components, programs, objects, modules, etc. are typically loaded into memory 230 from the mass storage device and/or ROM 240 upon power up.

In general, the routines executed to implement the embodiments of the invention, whether implemented as part of an operating system or a specific application, component, program, object, module or sequence of instructions will be referred to herein as “computer programs” or “software programs”, or simply “programs”. The computer programs typically comprise one or more instructions that are resident at various times in various memory and storage devices in a computer, and that, when read and executed by one or more processors in a computer, cause that computer to perform the steps necessary to execute steps or elements embodying the various aspects of the invention. Moreover, while the invention has and hereinafter will be described in the context of fully functioning computers and computer systems, those skilled in the art will appreciate that the various embodiments of the invention are capable of being distributed as a program product in a variety of forms, and that the invention applies equally regardless of the particular type of signal bearing media used to actually carry out the distribution. Examples of signal bearing media include but are not limited to recordable type media such as volatile and non-volatile memory devices, floppy and other removable disks, hard disk drives, optical disks (e.g., CD-ROM's, DVD's, etc.), among others, and transmission type media such as digital and analog communication links.

Position detecting mechanism 233, which is stored in memory 230 for execution on processor 220, calculates the position of a user's tap on the outside surface of the housing. According to the preferred embodiments of the present invention, position detecting mechanism 233 determines the position of the user's tap on the outside surface of housing 102 through triangulation using the tap signal from each of tap sensors 140. Numerous triangulation techniques for calculating position are well known, and thus only briefly discussed herein.

Triangulation techniques typically use at least one known distance along with angle measurements to calculate a subject's location. For example, as is well known in art of navigation, triangulation can be used to find the distance from a shore to a ship. A triangle is formed by the ship and two reference points on the shore. An observer at reference point one measures the angle between the ship and reference point two. An observer at reference point two measures the angle between the ship and reference point one. If the length between the two reference points is known, then the law of sines can be applied to find the distance between the shore and the ship. Hence, if a pair of tap sensors 140 of electronic device 100 provides angle measurements as the tap signal, then the law of cosines can be applied to calculate the location of the user's tap based on the angle measurements and the known distance between the tap sensor pair. At least one additional tap sensor pair may be used to reduce error in the calculation of the location of the user's tap (i.e., three tap sensors provide three tap sensor pairs).

Another type of triangulation (also referred to as “trilateration”) uses the known locations of three reference points and the measured distance between a subject and each reference point. Hence, if the three tap sensors 140 of electronic device 100 provide distance measurements as the tap signal, then the location of the user's tap can be calculated based on the distance measurements and the known locations of the three tap sensors 140.

In an alternative embodiment of the present invention, position detecting mechanism 233 may reside in and be executed by the one or more tap sensor 140. For example, as mentioned above, a single 3-in-1 tap sensor may be used to provide three tap signals for triangulation, in lieu of three separate tap sensors. In such a case, the 3-in-1 tap sensor may itself include a memory and microprocessor for storing and executing position detecting mechanism 233.

Matching mechanism 234, which is stored in memory 230 for execution on processor 220, matches the determined position of the user's tap against one or more virtual buttons configured on the outside surface of the housing. According to the preferred embodiments of the present invention, matching mechanism 234 matches the position of a user's tap determined by the position detecting mechanism 233 against virtual buttons that have been defined by that user and/or a software program. Hence, this matching operation is preferably specific to the particular user operating electronic device 100 and the particular software program that is currently running on electronic device 100. That is, each user and/or software program may configure the virtual buttons differently, i.e., the number, locations and sizes of the virtual buttons may be different for each user and/or software program.

Virtual button configuration mechanism 235, which is stored in memory 230 for execution on processor 220, provides for the dynamic configuration of one or more virtual buttons on the outside surface of the housing. According to the preferred embodiments of the present invention, virtual button configuration mechanism 235 defines the location and size of one or more virtual buttons based on input from a user and/or a software program loaded on electronic device 100. To facilitate a user's dynamic configuration of the virtual buttons, the outside surface of the housing preferably includes a hot key. The hot key may be an existing button, such as one of scrolling buttons 114 or shortcut buttons 116, or, alternatively, the hot key may be an additional button. In either case, virtual button configuration mechanism 235 preferably defines the size of each virtual button based on the length of time a user depresses the hot key, and preferably defines the location of each virtual button based on where the outside surface of the housing is tapped after a user depresses the hot key. In an alternative embodiment of the present invention, a user's input relative to the size and/or location of each virtual button may be provided through the use of menu items displayed on display 120 and selected using conventional user inputs, such as scrolling buttons 114 and/or shortcut buttons 116.

In accordance with the preferred embodiments of the present invention, the tap surface of the housing does not include indicia relative to the arrangement of the virtual buttons. Accordingly, the arrangement of the virtual buttons is preferably temporarily displayed on at least a portion of display 120. For example, it may be desirable to temporarily display the arrangement of the virtual buttons on a portion of display 120 when the outside surface of the housing is tapped, or when a request to map a new virtual button is received by the system. Preferably, the position of the user's tap calculated by position detecting mechanism 233 is temporarily displayed on display 120, along with the arrangement of the virtual buttons, to provide feedback to the user.

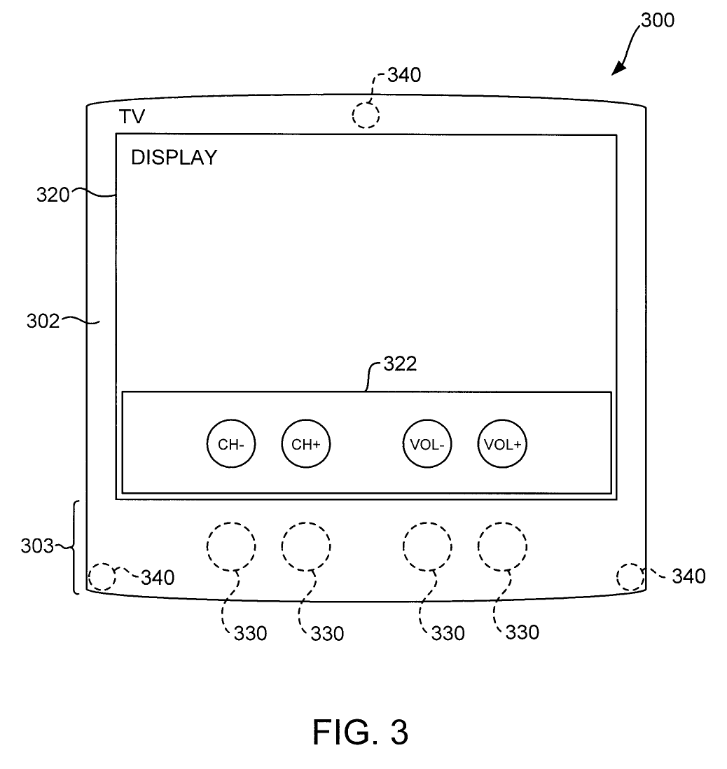

FIG. 3 is a front elevational view of an electronic device that constitutes a television 300 having virtual buttons 330 and tap sensors 340 in accordance with a preferred embodiment of the present invention. Virtual buttons 330 and tap sensors 340 in FIG. 3 are respectively analogous to virtual buttons 130 and tap sensors 140 in FIG. 1. As is conventional, television 300 includes a display 320. Preferably, the user input controls of television 300 are completely invisible. The outside surface of housing 302 includes at least a lower tap surface 303 that is devoid of conventional user input buttons. Virtual buttons 330 are more aesthetically appealing than conventional user input buttons, because virtual buttons 330 are not visible. The arrangement of virtual buttons 330 on tap surface 303 is preferably temporarily displayed on at least a portion (denoted by reference numeral 322) of display 320. For example, it may be desirable to temporarily display the arrangement of the virtual buttons 330 when the outside surface of the housing 302 is tapped, or when a request to map a new virtual button is received by the system. Preferably, the position of the user's tap as calculated by the position detecting mechanism is temporarily displayed on display 320, along with the arrangement of the virtual buttons 330, to provide feedback to the user. A user's input relative to the size and/or location of each virtual button 330 may be provided through the use of menu items displayed on display 320 and selected, for example, using conventional user inputs on a wireless remote control.

Virtual buttons according to the preferred embodiments of the present invention advantageously provide an uninterrupted barrier between the outside of the housing in the inside of the housing at the tap surface. This is a highly desirable feature for many applications. For example, virtual buttons may be utilized on the housing of an underwater electronic device where conventional user input buttons would allow water to seep into the device. Virtual buttons are also impervious to dirt and other contaminants which could foul conventional user input buttons.

Virtual buttons according to the preferred embodiments of the present invention may also be applied to security devices, such as automobile ignition switches; automobile, home and office door locks; bicycle locks; paddle locks; etc. The security device may be configured with several virtual buttons that must be tapped in sequence, or all at the same time, to unlock the device. Because the virtual buttons are preferably not visible, it would be difficult for unauthorized persons to unlock the device. Likewise, virtual buttons according to the preferred embodiments of the present invention may also be applied to control access to a computer, PDA, cellular phone, or other electronic device.

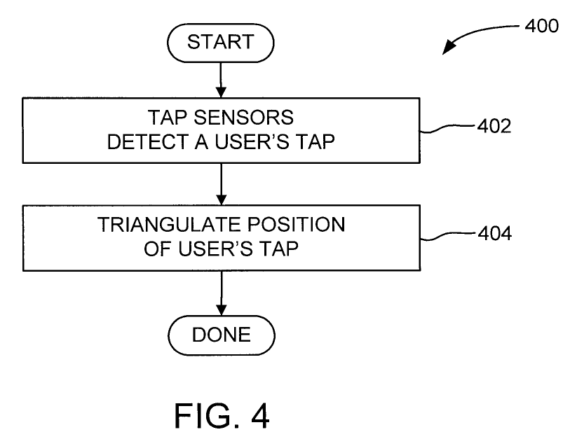

FIG. 4 is a flow diagram illustrating the activities of a position detecting mechanism 400 in accordance with the preferred embodiments of the present invention. The position detecting mechanism 400 illustrated in FIG. 4 corresponds with position detecting mechanism 233 shown in FIG. 2. Position detecting mechanism 400 begins when tap sensors detect a user's tap on the outside surface of the housing of an electronic device (step 402). Each tap sensor provides a tap signal in response to the user's tap. Next, position detecting mechanism 400 determines the position of the user's tap through triangulation based on the tap signals (step 404). For example, in a case where three tap sensors each provide a distance measurement as the tap signal, position detecting mechanism 400 in step 404 calculates the location of the user's tap based on the distance measurements and the known locations of the three tap sensors.

According to the preferred embodiments of the present invention, position detecting mechanism 400 determines the position of the user's tap through triangulation. Although the use of triangulation is preferred, those skilled in the art will appreciate that the position of the user's tap may be determined using techniques other than triangulation. For example, in a case where the virtual buttons are to be arranged along a line, the position detecting mechanism may determine the position of the user's tap along that line merely as a function of the tap signal from a single tap sensor, e.g., the amplitude of acoustic energy measured by a microphone decreases as the position of the user's tap becomes more distant from the microphone. Thus, those skilled in the art will recognize that the spirit and scope of the present invention is not limited to the use of triangulation techniques in the determination of the position of a user's tap.

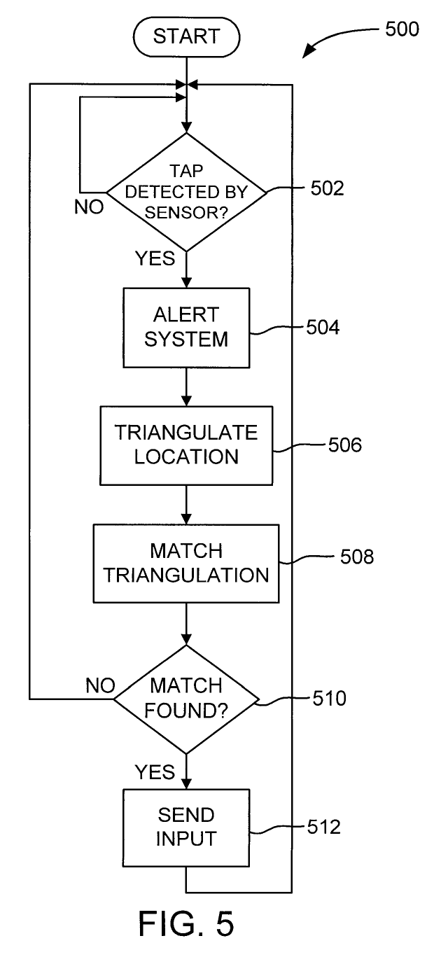

FIG. 5 is a flow diagram illustrating the activities of a matching mechanism 500 in accordance with the preferred embodiments of the present invention. The matching mechanism 500 illustrated in FIG. 5 corresponds with matching mechanism 234 shown in FIG. 2. In carrying out matching mechanism 500, the steps discussed below (steps 502-512) are performed. These steps are set forth in their preferred order. It must be understood, however, that the various steps may occur at different times relative to one another than shown, or may occur simultaneously. Moreover, those skilled in the art will appreciate that one or more of the steps may be omitted. Matching mechanism 500 begins with determination of whether the tap sensors have detected a user's tap on the outside surface of the housing of an electronic device (step 502). This step corresponds to step 402 in the position detecting mechanism 400 shown in FIG. 4. If the user's tap is not detected (step 502=NO), matching mechanism 500 returns to the start. In response to the detection of the user's tap (step 502=YES), matching mechanism 500 alerts the system (step 504). Matching mechanism 500 may, for example, awaken the electronic device from a standby mode and/or cause a representation of the tap surface and the arrangement of any virtual buttons thereon to be temporarily displayed on the electronic device's display. Next, matching mechanism 500 determines the position of the user's tap through triangulation based on tap signals from the tap sensors (step 506). This step corresponds to step 404 in the position detecting mechanism 400 shown in FIG. 4. Once the position of the user's tap is calculated, matching mechanism 500 may cause a representation of the user's tap to be added to the temporary display of the representation of the tap surface and the arrangement of any virtual buttons thereon. This provides a feedback to the user relative to how close his/her tap came to striking a virtual button. Similarly, matching mechanism 500 matches the position of the user's tap determined in step 506 against any virtual buttons (step 508). This may be accomplished by comparing the position of the user's tap and a boundary of each virtual button defined by the virtual button's location and size, which were previously configured by a user and/or a software program loaded on the electronic device. Matching mechanism 500 then determines whether a match has been found (step 510). If a match is found in step 510, an input corresponding to the matched virtual button is sent to the system (step 512). Matching mechanism 500 then returns to the start. On the other hand, if a match is not found in step 510, matching mechanism 500 then returns to the start.

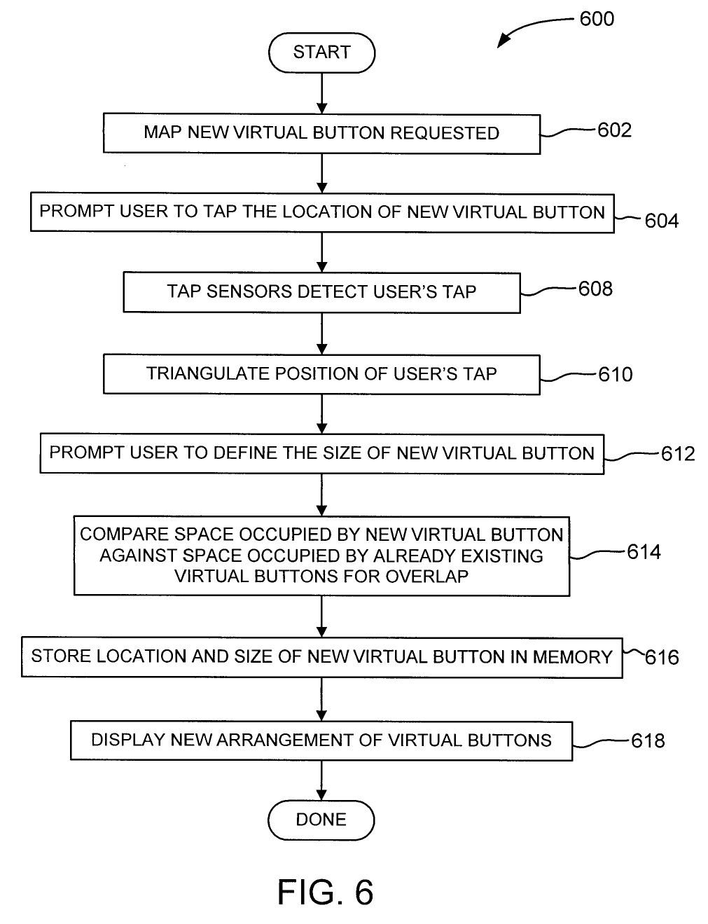

FIG. 6 is a flow diagram illustrating the activities of a virtual button configuration mechanism 600 in accordance with the preferred embodiments of the present invention. The virtual button configuration mechanism 600 illustrated in FIG. 6 corresponds with virtual button configuration mechanism 235 shown in FIG. 2. In carrying out virtual button configuration mechanism 600, the steps discussed below (steps 602-618) are performed. These steps are set forth in their preferred order. It must be understood, however, that the various steps may occur at different times relative to one another than shown, or may occur simultaneously. Moreover, those skilled in the art will appreciate that one or more of the steps may be omitted. Virtual button configuration mechanism 600 begins when the system receives a request to map a new virtual button (step 602). Such a request may be issued, for example, when a user performs a predetermined action such as depressing a hot key. Alternatively, such a request may be issued by a software program that is currently running on the electronic device. Next, the user is prompted to tap the location of the virtual button (step 604). For example, the user may be prompted using the electronic device's display and/or voice synthesis system. In addition, matching mechanism 500 may cause a representation of the tap surface and the arrangement of any already existing virtual buttons thereon to be temporarily displayed. In response to being prompted, the user then taps the outside surface of the housing of the electronic device. As a result, the tap sensors detect the user's tap on the outside surface of the housing (step 608). This step corresponds to step 402 in the position detecting mechanism 400 shown in FIG. 4. Next, virtual button configuration mechanism 600 determines the position of the user's tap through triangulation based on tap signals from the tap sensors (step 610). This step corresponds to step 404 in the position detecting mechanism 400 shown in FIG. 4. Once the position of the user's tap is calculated, matching mechanism 500 may cause a representation of the user's tap to be temporary displayed, along with the representation of the tap surface and the arrangement of any already existing virtual buttons thereon. This provides a feedback to the user relative to how close his/her tap came to any already existing virtual button.

In an alternative case where a software program currently running on the electronic device is to configure the location of the virtual button (in lieu of the user configuring the same), steps 604-610 may be omitted in favor of a step wherein the currently running program configures the virtual button's location.

Once the location of the virtual button is configured (either by the user or by the software program), the user is then prompted to define the size of the virtual button (step 612). For example, the user's input relative to the size of the virtual button may be provided by displaying options from which the user may select using conventional user inputs, such as scrolling buttons and/or shortcut buttons. In an alternative embodiment, the size of the virtual button can be configured by having a default size established by the user's initial tap. The user may then tap outside of the boundary to make the virtual button larger, or tap inside the boundary to make the virtual button smaller. Consequently, this alternative embodiment does not require a conventional user inputs or a hot key. Alternatively, virtual button configuration mechanism 600 may define the size of the virtual button based on the length of time the user depresses a hot key.

In an alternative case where a software program currently running on the electronic device is to configure the size of the virtual button (in lieu of the user configuring the same), step 612 may be omitted in favor of a step wherein the currently running program configures the virtual button's size.

Once the size of the virtual button is configured (either by the user of by the software program), the space occupied by the new virtual button is compared for overlap against the space occupied by any already existing virtual buttons (step 614). If there is overlap, the user is preferably presented with an opportunity to redefine the location and/or size of the new virtual button or delete one or both of the overlapping virtual buttons. The location and size of the new virtual button is then stored in memory (step 616). Preferably, the virtual button's location and size are stored in non-volatile memory and associated with the software program currently running on the electronic device and/or the user. In addition, virtual button configuration mechanism 600 causes a representation of tap surface and the new arrangement of the virtual buttons thereon to be temporarily displayed on the electronic device's display (step 618).

In another alternative embodiment, the application software program (or operating system) can define a virtual button by prompting the user to define the virtual button's size and/or location, or provide a default method in which a virtual button is defined automatically with respect to size and/or location so as to fit with existing virtual/nonvirtual buttons.

One skilled in the art will appreciate that many variations are possible within the scope of the present invention. For example, in the preferred embodiments there are three tap sensors. One skilled in the art will appreciate, however, that any number of tap sensors may be used. Also, in the preferred embodiments, triangulation is used to calculate the position of a user's tap. However, one skilled in the art will appreciate that techniques other than triangulation may be used to determine the position of a user's tap. Thus, while the present invention has been particularly shown and described with reference to preferred embodiments thereof, it will be understood by those skilled in the art that these and other changes in form and details may be made therein without departing from the spirit and scope of the present invention.

What is claimed is:

1. An electronic device, comprising:
a processor;
a memory coupled to the processor;
a housing having an outside surface, the housing at least partially enclosing the processor and the memory;
at least one tap sensor for providing a tap signal in response to a user's tap on the outside surface of the housing;
a position detecting mechanism to determine the position of a user's tap on the outside surface of the housing based on the tap signal;
a matching mechanism residing in the memory and executed by the processor to match the determined position of the user's tap and one or more virtual buttons configured on the outside surface of the housing.

2. The electronic device as recited in claim 1, wherein the at least one tap sensor comprises a plurality of accelerometers mounted at different locations relative to the outside surface of the housing, and wherein the position detecting mechanism determines the position of the user's tap through triangulation using the tap signal from each of the accelerometers.

3. The electronic device as recited in claim 1, wherein the position detecting mechanism resides in the memory and is executed by the processor.

4. The electronic device as recited in claim 1, wherein the outside surface of the housing includes a tap surface devoid of physical input buttons to provide an uninterrupted barrier between the outside of the housing and the inside of the housing at the tap surface.

5. The electronic device as recited in claim 1, further comprising a virtual button configuration mechanism residing in the memory and executed by the processor to dynamically configure one or more virtual buttons on the outside surface of the housing.

6. The electronic device as recited in claim 5, wherein the outside surface of the housing includes a hot key, and wherein the virtual button configuration mechanism defines the size of the one or more virtual buttons based on the length of time a user depresses the hot key.

7. The electronic device as recited in claim 5, wherein the outside surface of the housing includes a hot key, and wherein the virtual button configuration mechanism defines the location of the one or more virtual buttons based on where the outside surface of the housing is tapped after a user depresses the hot key.

8. The electronic device as recited in claim 5, wherein the virtual button configuration mechanism defines at least one of the size and the location of the one or more virtual buttons according to a software program residing in the memory and executed by the processor.

9. The electronic device as recited in claim 5, further comprising a display on the outside surface of the housing, and wherein the arrangement of the one or more virtual buttons is displayed on at least a portion of the display.

10. A method for entry of data or commands into an electronic device, comprising the steps of:
providing an electronic device with a housing having an outside surface, wherein the housing at least partially encloses a processor and a memory coupled to the processor, and wherein the housing has associated therewith at least one tap sensor that provides a tap signal in response to a user's tap on the outside surface of the housing;
determining the position of a user's tap on the outside surface of the housing based on the tap signal;
matching the determined position of the user's tap and one or more virtual buttons configured on the outside surface of the housing.

11. The method as recited in claim 10, wherein the at least one tap sensor comprises a plurality of accelerometers mounted at different locations relative to the outside surface of the housing, and wherein the step of determining the position of the user's tap includes the step of determining the position of the user's tap through triangulation using the tap signal from each of the accelerometers.

12. The method as recited in claim 10, further comprising the step of dynamically configuring one or more virtual buttons on the outside surface of the housing, and wherein the matching step includes the step of comparing the determined position of the user's tap and one or more portions of the outside surface of the housing defined in the configuring step as respectively constituting the one or more virtual buttons.

13. The method as recited in claim 12, wherein the outside surface of the housing includes a hot key, and wherein the configuring step includes the step of defining the size of the one or more virtual buttons based on the length of time a user depresses the hot key.

14. The method as recited in claim 12, wherein the outside surface of the housing includes a hot key, and wherein the configuring step includes the step of defining the location of the one or more virtual buttons based on where the outside surface of the housing is tapped after a user depresses the hot key.

15. The method as recited in claim 12, wherein the configuring step includes the step of defining at least one of the size and the location of the one or more virtual buttons according to a software program residing in the memory and executed by the processor.

16. The method as recited in claim 12, wherein the outside surface of the housing includes a display, and further comprising the step of displaying the arrangement of the one or more virtual buttons on at least a portion of the display.

17. A computer program product for entry of data or commands into an electronic device that includes a housing having an outside surface, wherein the housing at least partially encloses a processor and a memory coupled to the processor, wherein the housing has associated therewith at least one tap sensor that provides a tap signal in response to a user's tap on the outside surface of the housing, the computer program product comprising a plurality of computer executable instructions provided on computer readable signal bearing media, the program performing the steps of:
determining the position of a user's tap on the outside surface of the housing based on the tap signal;
matching the determined position of the user's tap and one or more virtual buttons configured on the outside surface of the housing.

18. The computer program product as recited in claim 17, wherein the at least one tap sensor comprises a plurality of accelerometers mounted at different locations relative to the outside surface of the housing, and wherein the step of determining the position of the user's tap includes the step of determining the position of the user's tap through triangulation using the tap signal from each of the accelerometers.

19. The computer program product as recited in claim 17, wherein the program further performs the step of dynamically configuring one or more virtual buttons on the outside surface of the housing, and wherein the matching step includes the step of comparing the determined position of the user's tap and one or more portions of the outside surface of the housing defined in the configuring step as respectively constituting the one or more virtual buttons.

20. The computer program product as recited in claim 17, wherein the signal bearing media comprises one of recordable media and transmission media.
